(19) United States
(12) Patent Application Publication
(10) Pub. No.: US 2009/0236163 A1
(43) Pub. Date: Sep. 24, 2009

(54) MOTOR VEHICLE WITH COMPRESSED-GAS TANK

(75) Inventors: Michael Wibbeke, Paderborn (DE); Andreas Wille, Paderborn (DE); Christian Handing, Langenberg (DE)

Correspondence Address: Henry M. Feiereisen;Henry M. Feiereisen, LLC, Suite 1501, 708 Third Avenue, New York, NY, 10017, US

(73) Assignee: Benteler Automobiltechnik GmbH, PADERBORN (DE)

(21) Appl. No.: 12/241,848

(22) Filed: Sep. 30, 2008

(30) Foreign Application Priority Data
Oct. 5, 2007 (DE) 10 2007 048 096.4

(51) Int. Cl. B60K 15/063

(52) U.S. Cl. 180/69.5

(57) ABSTRACT

A motor vehicle includes a compressed-gas tank which is disposed in a wheel well of a spare wheel. The compressed-gas tank has a circular-cylindrical configuration defined by an axis of rotation and includes tie elements in parallel relationship to the axis of rotation.

### CROSS-REFERENCES TO RELATED APPLICATIONS

This application claims the priority of German Patent Application, Serial No. 10 2007 048 096.4, filed Oct. 5, 2007, pursuant to 35 U.S.C. 119(a)-(d), the content of which is incorporated herein by reference in its entirety as if fully set forth herein.

### BACKGROUND OF THE INVENTION

The present invention relates, in general, to the field of motor vehicles.

Nothing in the following discussion of the state of the art is to be construed as an admission of prior art.

Mixtures of propane gas and butane gas can be liquefied at low pressures. As a result, large energy amounts can be stored in a small space, which is not the case when natural gas is involved. A gas mixture of propane gas and butane gas is also referred to as liquefied petroleum gas or LPG. Unlike LPG, natural gas is stored in gaseous form under a pressure of about 200 bar and is also referred to as compressed natural gas or CNG. The difference is storage pressure makes it necessary that the respective tanks comply with different standards.

In general, there are two different constructions of auxiliary tanks that need to be distinguished for storage of compressed gases in passenger cars. There is the spare-wheel well tank which is received in an existing spare-wheel well. While no loading area gets lost, the capacity of the spare-wheel well tank is limited and less than the other type of auxiliary tank, namely the cylinder tank. Cylinder tanks may be installed transversely behind the seat bench or in travel direction. The downside is the resultant loss in loading space. Compressed gas tanks that are disposed in the wheel well of a spare wheel involve LPG tanks which have to withstand significantly lower pressures than CNG tanks. Thus, CNG tanks are installed in cylinder form.

Belgium Pat. No. BE 442 554 A describes a compressed-gas tank shaped in the form of an annulus. The compressed-gas tank includes tie elements in parallel relationship to its axis of rotation and defines an interior space in the form of a circular ring. Valves are arranged in midsection of the annulus. This geometric configuration may also be applicable for LPG tanks; however this has the drawback that the available space in the wheel well of a spare wheel is not fully utilized for the tank volume.

It would therefore be desirable and advantageous to provide an improved motor vehicle with compressed-gas tank to address this problem and to obviate other prior art shortcomings.

### SUMMARY OF THE INVENTION

According to one aspect of the present invention, a motor vehicle includes a compressed-gas tank disposed in a wheel well of a spare wheel, the compressed-gas tank having a circular-cylindrical configuration, which defines an axis of rotation, and including tie elements in parallel relationship to the axis of rotation.

The present invention resolves prior art problems by configuring the compressed-gas tank of circular-cylindrical shape, with the tie elements imparting the compressed-gas tank with the necessary stable shape, even when exposed to very high pressures, especially when the compressed-gas tank involves a CNG tank which is subject to a pressure of about 200 bar in operation. The reference to the term “circular cylindrical” in connection with the configuration of the compressed-gas tank does not only relate to the outer contour, which normally is suited to the spherical wheel well, but also relates to the hollow space enclosed by the compressed-gas tank. This does not involve a torus or an annular space but involves indeed a circular-cylindrical hollow body which adjacent to the axis of rotation has a midsection which, unlike a donut-shaped or torus-shaped configuration, is available for storage of gases so that the space in the area of the wheel well is more effectively utilized in comparison to donut-shaped or torus-shaped compressed-gas tanks.

According to another feature of the present invention, the compressed-gas tank may have a bursting pressure of greater than 300 bar, or even greater than 600 bar, when the compressed-gas tank is filled with hydrogen, for example.

The compressed-gas tank may have rounded edge zones in a transition between its cylinder wall surface and its opposite end surfaces. This contour is especially advantageous when subjected to high internal pressures as the envelope of the compressed-gas tank virtually behaves like a membrane when the forces are at equilibrium. The flattened, circular-cylindrical geometry of the compressed-gas tank is ensured by the internal tie elements which are disposed in parallel relationship to the axis of rotation. The tie elements assume the task of connecting the opposite upper and lower sides of the compressed-gas tank to one another and absorbing the tensile stress generated by the internal pressure. The tie elements may be configured as tie rod or traction rope and prevent an unwanted outward bulging of the compressed-gas tank, when subject to the internal pressure.

According to another feature of the present invention, the tie elements can be arranged in the form of a ring. The center of the ring-shaped disposition should hereby coincide with the axis of rotation of the circular-cylindrical compressed-gas tank. In view of the circular-cylindrical configuration of the compressed-gas tank, it may be advantageous to arrange the tie elements evenly in circumferential spaced-apart relationship, thereby realizing an even load and stress distribution.

According to another feature of the present invention, the ring of tie elements may involve 3 to 12 tie elements. Currently preferred is a disposition of 6 tie elements. Such a number of tie elements results in a constant stress distribution within the compressed-gas tank, absent any stress peaks and without adversely affecting the viability of manufacturing the compressed-gas tank as a result of the installation of additional tie elements.

According to another feature of the present invention, the tie elements may be arranged in the form of a plurality of rings disposed in concentric relationship. The disposition of tie elements along several rings may be advisable, when the compressed-gas tank has a greater outer diameter. Suitably, the tie elements of adjacent two rings may be arranged in circumferential offset relationship. This also results in a more even stress distribution in the wall of the compressed-gas tank.

According to another feature of the present invention, one of the tie elements may be arranged in an area of the axis of rotation. The presence of such a centrally disposed tie element enables the realization of ring-shaped arrangements with greater diameters, without encountering excessive material stress of the compressed-gas tank in midsection thereof.

According to another feature of the present invention, at least one of the tie elements may be configured to form a charging or purging channel. As the tie elements may have a tubular configuration, their inner space can be utilized to supply or withdraw compressed gas. As a result, there is no need for providing further openings in the wall of the compressed-gas tank.

In particular, when the interior space of the compressed-gas tank is filled with a storage medium for the compressed gas, it is advantageous to introduce the compressed gas via several feed sites into the storage medium to attain a more rapid charging and even distribution of the compressed gas.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of a compressed-gas tank according to the present invention, received in a wheel well;

FIG. 2 is a perspective illustration of the compressed-gas tank outside the wheel well;

FIG. 3 is a perspective illustration of the compressed-gas tank, which has been opened to show internal parts and. the interior of the bottom shell;

FIG. 4 is a vertical section of the compressed-gas tank of FIG. 2;

FIG. 5 is another vertical section of the compressed-gas tank of FIG. 2; and

FIG. 6 is a schematic horizontal section of the compressed-gas tank.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

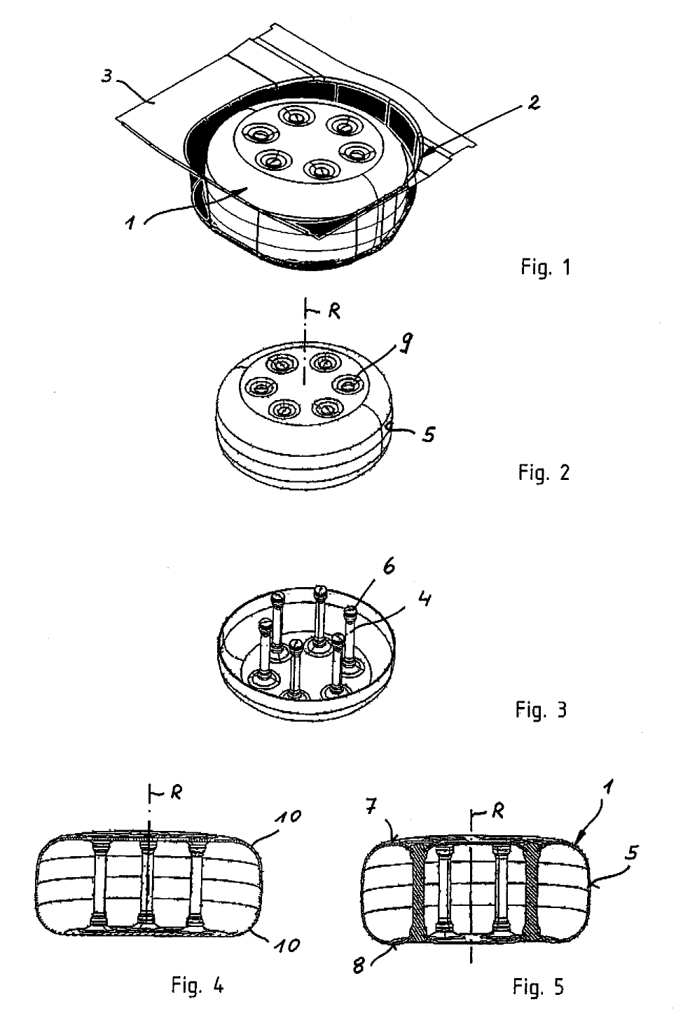

Turning now to the drawing, and in particular to FIG. 1, there is shown a perspective illustration of a compressed-gas tank according to the present invention, generally designated by reference numeral 1 and received in a wheel well 2 of a motor vehicle. Instead of the compressed-gas tank 1, the wheel well 2 may also receive a spare wheel which is not shown in greater detail. The wheel well 2 is formed in a loading bottom 3 which is only indicated here. The wheel well 2 is normally closed by a cover which is placed upon the loading bottom.

The compressed-gas tank 1 has a circular-cylindrical configuration, as clearly shown in FIGS. 2 and 3. In other words, the configuration of the compressed-gas tank 1 is spherical in relation to its outer circumference and defines an axis of rotation R which extends in a vertical direction in the drawing plane of FIGS. 2 and 3. The compressed-gas tank 1 is provided to receive natural gas under high pressure and is additionally reinforced by tie elements 4 which are arranged inside the compressed-gas tank 1. The tie elements 4 extend in parallel relationship to the axis of rotation R. All tie elements 4 are positioned at a same distance to the axis of rotation R and are disposed evenly about the circumference so as to establish a ring-shaped arrangement. In the non-limiting example of FIGS. 2, and 3, the arrangement of six tie elements 4 is contemplated at a distance to the axis of rotation R in correspondence to the distance to a cylinder wall surface 5.

As can be seen in FIGS. 3, 4 and 5, all tie elements 4 have identical configuration. FIG. 5 also shows that the tie elements 4 are designed as solid tie rods. The tie elements 4 have anchoring heads 6 which engage openings in opposite end surfaces 7, 8 of the compressed-gas tank 1 and are snugly sealed with the end surfaces 7, 8. The tie elements 4 are sized to not project beyond the end surfaces 7, 8 as their anchoring heads 6 are placed within trough-shaped depressions 9. Disregarding the depressions 9, the compressed-gas tank 1 has thus a substantially circular-cylindrical body. Suitably, the edge zones of the circular-cylindrical body or compressed-gas tank 1 are rounded. In other words, the transition zones 10 between the cylinder wall surface 5 and the end surfaces 7, 8 are rounded. The rounded transition zones 10 extend overall by about 50% of the overall height of the compressed-gas tank 11 as measured in the direction of the axis of rotation R. As a result, the circular-cylindrically shaped area is also about 50% of the overall height.

The compressed-gas tank 1 is suitably made of identical top and bottom shells which abut one another in the area of the cylindrical wall surface and are joined together there. The compressed-gas tank 1 is provided in a manner not shown in detail with at least one port for supply and purging, whereby the port may be arranged in the area of the cylindrical wall surface as well as in the area of the end surfaces.

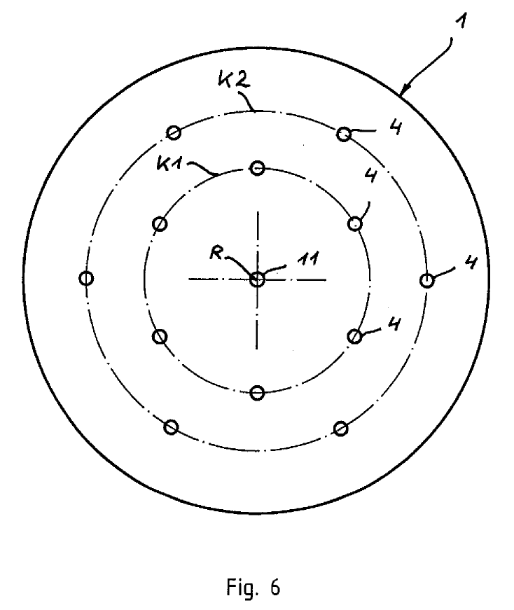

FIG. 6 shows a purely schematic horizontal section of a compressed-gas tank 1 which has six tie elements 4 lined up about one circle K1 and six tie elements 4 lined up about a second circle K2, whereby the circles K1, K2 are arranged in concentric relationship. The tie elements 4 are evenly circumferentially distributed about the circles K1, K2 in offset relationship. In other words, the tie elements 4 of the inner circle K1 are arranged at 30°, 90°, 150° . . . , whereas the tie elements 4 about the outer circle area arranged at 0°, 60°, 120° . . . , i.e. offset by 30°. In addition, a further tie element 11 is disposed in the middle of the compressed-gas tank 1, i.e. in the area of the axis of rotation R. The tie element 11 serves at the same time as charging and purging channel, and thus has at least one opening porting into the interior space of the compressed-gas tank 1, a port on the outside of the compressed-gas tank 1, and a passageway for fluidly connecting the port with the opening. Other tie elements 4 may also be constructed in this way to enable a rapid filling and emptying of the compressed-gas tank 1.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A motor vehicle, comprising a compressed-gas tank disposed in a wheel well of a spare wheel, said compressed-gas tank having a circular-cylindrical configuration, which defines an axis of rotation, and including tie elements in parallel relationship to the axis of rotation.

2. The motor vehicle of claim 1, wherein the compressed-gas tank is a compressed natural gas (CNG) tank.

3. The motor vehicle of claim 1, wherein the compressed-gas tank has a bursting pressure of greater than 300 bar.

4. The motor vehicle of claim 1, wherein the compressed-gas tank has a bursting pressure of greater than 600 bar.

5. The motor vehicle of claim 1, wherein the tie elements are arranged in the form of a ring.

6. The motor vehicle of claim 5, wherein the ring defines a center which coincides with the axis of rotation of the compressed-gas tank.

7. The motor vehicle of claim 1, wherein the tie elements are arranged evenly in circumferential spaced-apart relationship.

8. The motor vehicle of claim 5, wherein the ring of tie elements involves 3 to 12 tie elements.

9. The motor vehicle of claim 5, wherein the ring of tie elements involves 6 tie elements.

10. The motor vehicle of claim 1, wherein the tie elements are arranged in the form of a plurality of rings disposed in concentric relationship.

11. The motor vehicle of claim 10, wherein the tie elements of adjacent two rings are arranged in circumferential offset relationship.

12. The motor vehicle of claim 1, wherein one of the tie elements is arranged in an area of the axis of rotation.

13. The motor vehicle of claim 1, wherein at least one of the tie elements is configured to form a charging or purging channel.

14. The motor vehicle of claim 1, wherein the compressed-gas tank has rounded edge zones in a transition between its cylinder wall surface and its opposite end surfaces.

15. The motor vehicle of claim 1, wherein the tie elements have a tubular configuration.

16. The motor vehicle of claim 1, wherein the compressed-gas tank has a cylinder wall surface, said tie elements being spaced from the axis of rotation at a distance which corresponds to a distance of the tie elements to the cylinder wall surface of the compressed-gas tank.

17. The motor vehicle of claim 1, wherein each of the tie elements is a solid tie rod.
